(19) United States
(12) Patent Application Publication
(10) Pub. No.: US 2023/0179443 A1
(43) Pub. Date: Jun. 8, 2023

(54) GATEWAY AND METHOD OF PROCESSING CAN MESSAGE

(71) Applicants: Hyundai Motor Company, Seoul (KR); Kia Corporation, Seoul (KR); Kyungshin Corp., Incheon (KR)

(72) Inventors: Seung Su Kim, Seoul (KR); Jae Woo Kim, Incheon (KR)

(21) Appl. No.: 17/737,085

(22) Filed: May 5, 2022

(30) Foreign Application Priority Data
Dec. 6, 2021 (KR) 10-2021-0173162

(51) Int. Cl. H04L 12/40; H04L 45/02

(52) U.S. Cl. CPC H04L 12/40032; H04L 45/02; H04L 2012/40215

(57) ABSTRACT

Disclosed are a gateway and a method of processing a controller area network (CAN) message. The gateway includes storage that includes a memory in which a controller area network (CAN) message including vehicle state information is stored, and a processing device that filters the CAN message to determine a type of a memory in which the CAN message is to be stored, and determines a scheme of processing the CAN message based on the determined type of the memory. Therefore, it is possible to reduce the load on the vehicle central processing unit by reducing the memory usage of the gateway, and design more routing paths.

### CROSS-REFERENCE TO RELATED APPLICATION

This application claims the benefit of priority to Korean Patent Application No. 10-2021-0173162, filed in the Korean Intellectual Property Office on Dec. 6, 2021, the entire contents of which are incorporated herein by reference.

### TECHNICAL FIELD

The present disclosure relates to a gateway and a method of processing a controller area network (CAN) message.

### BACKGROUND

Various electronic control units are embedded in a vehicle, and the number of electronic control units has been increased as technologies for improving the driver's convenience as well as the driving system have been recently developed.

As the number of electronic control units increases, information obtained from various sensors is transmitted and received as a CAN message using CAN communication, and the CAN message passes through a gateway to move to another network. The gateway performs routing to establish one among a plurality of paths such that the CAN message is transmitted over a short distance in the shortest time.

However, as the number of CAN messages output compared to a single input increases due to an increase in the vehicle network, and the number of routing increases because the CAN message is divided and routed when the data length between networks is not compatible. In the case of a connected car, a diagnostic path for Ethernet communication is added, thereby increasing the memory usage of the gateway.

When the routing path of the CAN message increases, the memory usage according to the path increase further increases, thereby causing a memory shortage in the gateway.

### SUMMARY

An aspect of the present disclosure provides a gateway capable of reducing memory usage and a method of processing a CAN message thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a gateway comprises or includes storage that comprises or includes a memory in which a controller area network (CAN) message comprising or including vehicle state information is stored, and a processing device that filters the CAN message to determine a type of a memory in which the CAN message is to be stored, and determines a scheme of processing the CAN message based on the determined type of the memory.

The storage may include a first memory and a second memory of a different type from the first memory.

The processing device may determine to route the CAN message in a first scheme when it is determined that the CAN message is stored in the first memory.

In the first scheme, a routing device included in the processing device may transmit the CAN message from a driver layer to an interface layer, and transmit the CAN message from the interface layer to a service layer to design routing path information.

The processing device may collect the CAN message when it is determined that the CAN message is stored in the first memory and the second memory.

The processing device may determine to route the CAN message in a second scheme when it is determined that the CAN message is stored in the second memory.

In the second scheme, a data collection device included in the processing device may obtain a routing path corresponding to the CAN message from a routing table included in a driver layer.

The routing table may comprise or include a routing path corresponding to at least one CAN message.

According to another aspect of the present disclosure, a method of processing a controller area network (CAN) message comprises or includes filtering, by a processing device, the CAN message including vehicle state information to determine a type of a memory in which the CAN message is to be stored, and determining, by the processing device, a scheme of processing the CAN message based on the determined type of the memory.

The memory may comprise or include a first memory and a second memory of a different type from the first memory.

The determining of the processing scheme may comprise or include determining to route the CAN message in a first scheme when it is determined that the CAN message is stored in the first memory.

The first scheme may include transmitting, by a routing device included in the processing device, the CAN message from a driver layer to an interface layer, and transmitting, by the processing device, the CAN message from the interface layer to a service layer to design routing path information.

The determining of the processing scheme may include collecting the CAN message when it is determined that the CAN message is stored in the first memory and the second memory.

The determining of the processing scheme may include determining to route the CAN message in a second scheme when it is determined that the CAN message is stored in the second memory.

The second scheme may include obtaining by a data collection device included in the processing device, a routing path corresponding to the CAN message from a routing table included in the driver layer.

The routing table may include a routing path corresponding to at least one CAN message.

Further provided are vehicles that comprise a gateway as disclosed herein, including a passenger vehicle, truck other vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram schematically illustrating a gateway according to an embodiment of the present disclosure;

FIG. 2 is a diagram schematically illustrating a routing scheme according to an embodiment of the present disclosure;

FIG. 3 is a flowchart illustrating a method of processing a CAN message according to an embodiment of the present disclosure; and

FIG. 4 is a block diagram illustrating a computing system for executing a method according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

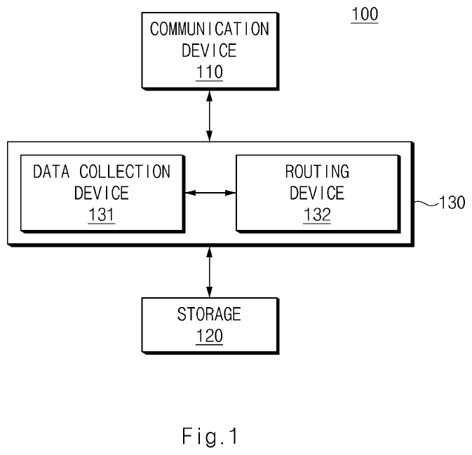

FIG. 1 is a block diagram schematically illustrating the configuration of a gateway according to an embodiment of the present disclosure.

As illustrated in FIG. 1, a gateway 100 may include a communication device 110, storage 120 and a processor 130.

The communication device 110 may receive a controller area network (CAN) message corresponding to information obtained from various sensors from one or more network domains. In this case, the CAN message may include CAN message ID and data information (vehicle state information). In detail, a first ID may be assigned to the CAN message such that high priority is assigned to a message (obtained from a drivetrain sensor) that can have a significant impact on driving and safety of the vehicle, and a second ID may be assigned to the CAN message such that lower priority is assigned to a message (obtained from a sensor for providing convenience to a driver, such as a seat sensor or an air conditioning sensor) that does not significantly affect driving and safety. In addition, when the routing path for the CAN message is obtained, the communication device 110 may transmit the CAN message to another network domain to be transmitted. The communication device 110 may be implemented as driver software.

The storage 120 may include different types of memories in which CAN messages received through the communication device 110 are stored, and according to an embodiment, may include a first memory and a second memory. The storage 120 may include a hardware memory, and may include a reception buffer memory and a reception FIFO memory.

The processor 130 may be implemented with various processing devices such as a microprocessor having a built-in semiconductor chip capable of performing operations or execution of various commands, and may control an operation of a gateway according to an embodiment of the present disclosure.

According to an embodiment, the processor 130 may be largely divided into a data collection device 131 and a routing device 132 according to the characteristics of the operation performed.

According to an embodiment of the present disclosure, an AUTOSAR platform structure may be applied to the processor 130, and a software layer required for the data collection device 131 and the routing device 132 may include a driver layer (CAN driver), an interface layer (CAN interface) and a service layer (protocol data unit router: PDUR). According to an embodiment of the present disclosure, it is possible to design a routing table to be included in the driver layer. The routing table may include routing paths corresponding to at least one CAN message.

The processor 130 may filter the CAN message received at the communication device 110 according to the CAN message ID through at least one message filter to determine the memory type in which the CAN message is to be stored, and a processing manner according to the memory type.

According to an embodiment, the processor 130 may determine that the CAN message is to be stored in the first memory because the first ID is assigned to the CAN when the CAN message is a message (obtained from the drivetrain sensor) that can significantly affect the driving and safety of the vehicle.

In addition, when the CAN message is a message (obtained from a sensor for providing convenience to the driver, such as a seat sensor or an air conditioning sensor) that does not significantly affect driving and safety, the second ID may be assigned to the CAN message so that the processor 130 determines that the CAN message is stored in the second memory.

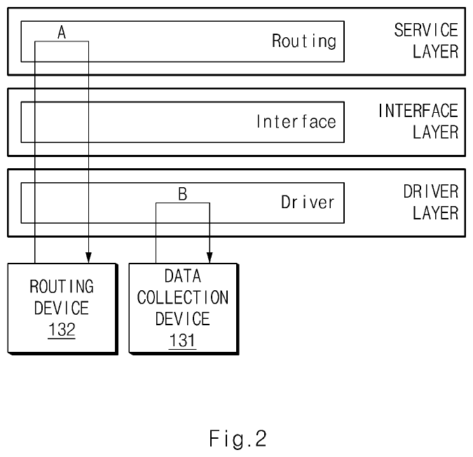

According to an embodiment, when it is determined that the CAN message is stored in the first memory, the processor 130 may determine the routing scheme as the first scheme. Meanwhile, when it is determined that the CAN message is stored in the second memory, the processor 130 may determine the router method as the second scheme. The first scheme and the second scheme will be described in more detail with reference to FIG. 2.

FIG. 2 is a diagram schematically illustrating a routing scheme according to an embodiment of the present disclosure.

When the processor 130 determines the routing scheme as the first scheme, more memory usage is required so that the routing device 132 may design (set) a routing path. According to an embodiment, the routing device 132 may design (set) routing path information in a driver layer, an interface layer and a service layer. In more detail, the routing device 132 may transmit the CAN message received in the driver layer to the interface layer as denoted as ‘A’, and transmit the CAN message received in the interface layer to the service layer, so that routing path information may be designed (set) in each layer.

In addition, the routing device 132 may copy the routing path information from the service layer to the driver layer, and transmit the CAN message to the network to be transmitted according to the routing path through the communication device 110.

When the routing scheme is determined as the second scheme, the processor 130 may allow the data collection device 131 to obtain the routing path. In more detail, the data collection device 131 may obtain the routing path information corresponding to the CAN message from the routing table included in the driver layer (CAN driver) as denoted as ‘B’, and collect the CAN message received through the communication device 110. In addition, the data collection device 131 may transmit the CAN message to the network to be transmitted along the routing path through the communication device 110.

Meanwhile, when it is determined that the CAN message is stored in the first memory and the second memory, the processor 130 may process the CAN message to enable the data collection device 131 to collect the CAN message.

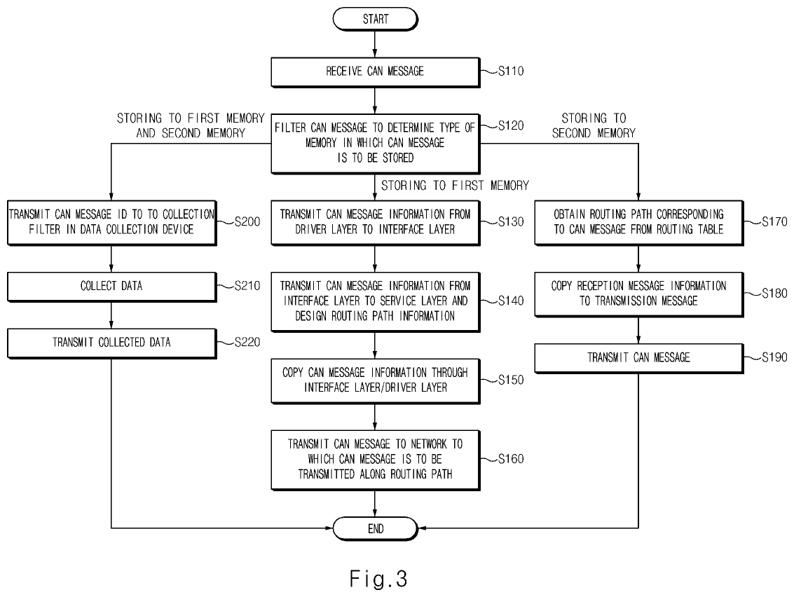

FIG. 3 is a flowchart illustrating a method of processing a CAN message according to an embodiment of the present disclosure.

As illustrated in FIG. 3, the communication device 110 may receive a CAN message in S110. In S120, the processor 130 may determine a memory type to be stored by filtering the received CAN message according to the CAN message ID.

When it is determined in S120 that the CAN message is stored in the first memory, in S130, the processor 130 may process the CAN message to allow the routing device 132 to transmit the CAN message information from the driver layer to the interface layer. When the CAN message information is transmitted to the interface layer, in S140, the processor 130 may allow the routing device 132 to transmit the CAN message information from the interface layer to the service layer, thereby designing (setting) routing path information.

When the routing path information of the CAN message is designed, the processor 130 may copy the routing path information through the interface layer and the driver layer in S150, and transmit the CAN message to a network to be transmitted along the routing path through the communication device 110 in S160.

Meanwhile, when it is determined in S120 that the CAN message is stored in the second memory, in S170, the processor 130 may obtain the routing path corresponding to the CAN message from the router table included in the driver layer.

When the routing path of the CAN message is obtained, the processor 130 may copy the CAN message of which the routing path information is obtained as a transmission message in S180, and transmit the CAN message to the network to be transmitted along according to the routing path through the communication device 110 in S190.

When it is determined that the CAN message is stored in both the first memory and the second memory, in S200, the processor 130 may transmit the CAN message ID to the collection filter in the data collection device 131. Then, the processor 130 may collect the CAN message ID based on the CAN message ID in S210 and may transmit the collected CAN message to the communication device 110 in S220.

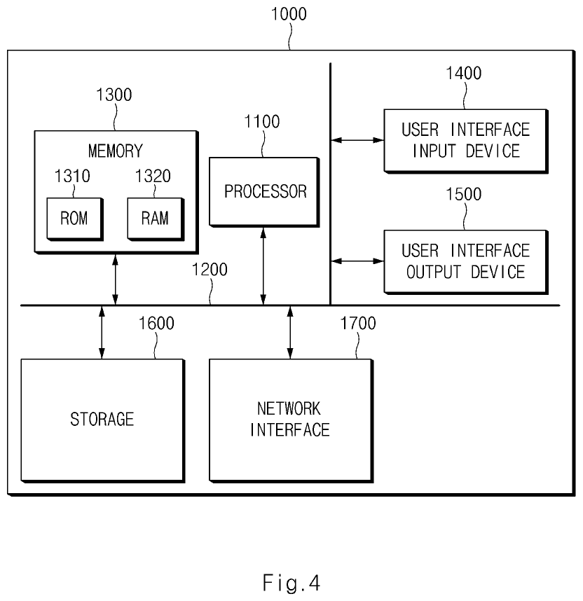

FIG. 4 is a block diagram illustrating a computing system for executing a method according to an embodiment of the present disclosure.

Referring to FIG. 4, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The gateway and the method of processing a CAN message according to an embodiment of the present disclosure can reduce the load on the vehicle central processing unit by reducing the memory usage of the gate, and can design more routing paths.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A gateway comprising:
storage comprising a memory in which a controller area network (CAN) message comprising vehicle state information is stored; and
a processing device configured to filter the CAN message to determine a type of a memory in which the CAN message is to be stored, and determine a scheme of processing the CAN message based on the determined type of the memory.

2. The gateway of claim 1, wherein the storage comprises a first memory and a second memory of a different type from the first memory.

3. The gateway of claim 2, wherein the processing device is configured to determine to route the CAN message in a first scheme when it is determined that the CAN message is stored in the first memory.

4. The gateway of claim 3, wherein, in the first scheme, a routing device included in the processing device is configured to transmit the CAN message from a driver layer to an interface layer, and transmit the CAN message from the interface layer to a service layer to design routing path information.

5. The gateway of claim 2, wherein the processing device is configured to collect the CAN message when it is determined that the CAN message is stored in the first memory and the second memory.

6. The gateway of claim 2, wherein the processing device is configured to determine to route the CAN message in a second scheme when it is determined that the CAN message is stored in the second memory.

7. The gateway of claim 6, wherein, in the second scheme, a data collection device included in the processing device is configured to obtain a routing path corresponding to the CAN message from a routing table included in a driver layer.

8. The gateway of claim 7, wherein the routing table comprises a routing path corresponding to at least one CAN message.

9. A method of processing a controller area network (CAN) message, the method comprising:
filtering, by a processing device, the CAN message that comprises vehicle state information to determine a type of a memory in which the CAN message is to be stored,
determining, by the processing device, a scheme of processing the CAN message based on the determined type of the memory.

10. The method of claim 9, wherein the memory comprises a first memory and a second memory of a different type from the first memory.

11. The method of claim 10, wherein the determining of the processing scheme comprises:
determining to route the CAN message in a first scheme when it is determined that the CAN message is stored in the first memory.

12. The method of claim 11, wherein the first scheme comprises transmitting, by a routing device included in the processing device, the CAN message from a driver layer to an interface layer, and transmitting, by the processing device, the CAN message from the interface layer to a service layer to design routing path information.

13. The method of claim 10, wherein the determining of the processing scheme comprises:
collecting the CAN message when it is determined that the CAN message is stored in the first memory and the second memory.

14. The method of claim 10, wherein the determining of the processing scheme comprises:
determining to route the CAN message in a second scheme when it is determined that the CAN message is stored in the second memory.

15. The method of claim 14, wherein the second scheme comprises:
obtaining by a data collection device included in the processing device, a routing path corresponding to the CAN message from a routing table included in a driver layer.

16. The method of claim 15, wherein the routing table comprises a routing path corresponding to at least one CAN message.
